(19) United States
(12) Patent Application Publication
(10) Pub. No.: US 2010/0142779 A1
(43) Pub. Date: Jun. 10, 2010

(54) METHOD AND APPARATUS FOR LOCATING A PHYSIOLOGICAL FEATURE OF INTEREST IN IMAGE DATA

(76) Inventors: Sarah Bond, Oxford (GB); Timor Kadir, Oxford (GB)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/630,072

(22) Filed: Dec. 3, 2009

(30) Foreign Application Priority Data
Dec. 3, 2008 (GB) 0822063.4

(51) Int. Cl. G06K 9/62

(52) U.S. Cl. 382/128

(57) ABSTRACT

In a method and apparatus for locating a physiological or anatomical feature of interest in image data of a subject, intensity projection line along a specified axis of an image volume of the image data is generated from the image data. The projection line is compared to at least one predetermined reference projection line for that specified axis, and the comparison is used to delineate an estimated feature region, containing the feature of interest, within the image volume.

### BACKGROUND OF THE INVENTION

1. Field of the Invention

The present invention is directed to a method and an apparatus for locating a physiological or anatomical feature of interest in image data of a subject.

2. Description of the Prior Art

In the medical imaging field, several imaging schemes are known. For example PET (Positron Emission Tomography) is a method for imaging a subject in 3D using an injected radio-active substance which is processed in the body, typically resulting in an image indicating one or more biological functions. For example, in assessment of heart disease, a rubidium or ammonia tracer can be used with scans concentrating on the perfusion of the left ventricle of the heart.

The automated delineation of the boundary of anatomical objects, such as lungs, heart, kidneys and liver is an important step in many medical imaging applications. For example, in cardiac perfusion, automated analysis of the myocardium typically proceeds by first segmenting the Left Ventricle (LV) wall, then re-slicing the volume to the standard orientation, followed by polar plot analysis. Analysis of cardiac perfusion using hybrid modalities such as PET/CT and SPECT/CT also requires correction of any misalignment between the two scans. This can be achieved using a “local” automated registration between the PET or SPECT and CT images around the LV. Here, “local” means that the registration attempts to align structures around the LV only. One way this can be achieved is to bias the registration algorithm such that it considers the structures around the LV in greater priority to others. To achieve this, a crude segmentation of the LV is necessary.

For best performance, segmentation algorithms typically require, as an initialization, an estimation of the position and extent of the anatomical object of interest. This may, for example, be a bounding box placed around the organ. If this is to be a pre-processing step, any method needs to be both fast and accurate.

In medical imaging protocols such as PET and SPECT, the fastest methods to find the segmentation usually involve 1-D searches and projections of the image intensities. One previously considered method is disclosed in U.S. Pat. No. 6,065,475. In cardiac imaging, it is expected that the heart will be one of the organs of highest activity. In the case of bounding box placement around the LV, 1-D maximum intensity projections are typically used. These projections are then processed using manually tuned heuristics in the form of peak detection and thresholding to find the best segmentation. These heuristics can be made to work, but the design process is ad-hoc and time consuming. Such algorithms tend to be quite brittle and exhibit poor robustness to image noise and variations in object shape.

Other different methods are available which take a separate approach using prior knowledge in the form of template matching or model fitting. All such methods involve a search and optimization in order to find the best segmentation of the region of interest. However, such methods tend to be complex and computationally expensive.

### SUMMARY OF THE INVENTION

The present invention aims to address the above-discussed problems and to provide improvements to known devices and methods.

In general terms, in an embodiment of the invention, a method for locating a physiological or anatomical feature of interest in image data of a subject includes generating from the image data an intensity projection line along a specified axis of an image volume of the image data, comparing the projection line to at least one predetermined reference projection line for that specified axis, and using the comparison to delineate an estimated feature region, containing the feature of interest, within the image volume.

This method provides a fast and robust way to automatically delineate a feature region in an image.

Preferably, the method includes comparing the projection line to each of a set of predetermined reference projection lines.

Suitably, the projection line generated is one of: a maximum intensity projection line; and a summed intensity projection line.

More preferably, the steps of generating and comparing include generating the intensity projection line along each of three orthogonal axes of the image volume, and comparing each generated projection line to at least one respective reference projection line for that axis.

Still more preferably, the reference projection lines are derived from a three-dimensional training dataset, the dataset comprising a plurality of training images.

This allows a reliable dataset for the comparison, producing a consistent and robust result.

Preferably, a set of boundary limits for a reference feature region is associated with each reference projection line.

In one embodiment, the steps of generating and comparing include, for a first of the three generated projection lines along a first axis, following the comparison of the first projection line with a first reference projection line, cropping the test dataset to the boundary limits associated with the first reference projection line in the direction of the first axis, deriving a second reference projection line from the cropped test dataset, and comparing a second of the three generated projection lines along a second axis with said second reference projection line.

This reduces the size of the test dataset during the processing, reducing the processing power required to complete the operation.

In another embodiment, the step of comparing the projection line to at least one predetermined reference projection line includes comparing a section of the predetermined reference projection line, between the set boundary limits, to locations along the projection line from a test dataset, and using a difference measure to determine the similarity between the section and the projection line at each location.

Suitably, the method further includes determining a closest match of the section to the projection line where the difference measure has a minimum value.

In an embodiment, the step of using the comparison to delineate an estimated feature region includes identifying the boundary limits associated with a closest matching reference projection line to the projection line from the test dataset, and applying the identified boundary limits to the test dataset projection line to segment the test data set projection line.

Suitably, reference projection lines of the set are grouped according to a similarity measure between respective reference projection lines.

In another embodiment of the invention a method for locating a physiological or anatomical feature of interest in image data of a subject captured by an imaging apparatus, includes generating in a processor, from the image data an intensity projection line along a specified axis of an image volume of the image data, comparing, in the processor, the projection line to at least one predetermined reference projection line for that specified axis, using, in the processor, the comparison to delineate an estimated feature region, containing the feature of interest, within the image volume, and displaying the estimated feature region on a display device connected to the processor.

The invention also encompasses an apparatus for locating a physiological or anatomical feature of interest in image data of a subject captured by an imaging apparatus, including a processor configured to generate from the image data an intensity projection line along a specified axis of an image volume of the image data, to compare the projection line to at least one predetermined reference projection line for that specified axis, and to use the comparison to delineate an estimated feature region, containing the feature of interest, within the image volume; and a display device for displaying the estimated feature region.

The invention also encompasses a computer-readable medium encoded with programming instructions that, when loaded into a processor, cause the processor to execute the method described above, as well as all embodiments.

### BRIEF DESCRIPTION OF THE DRAWINGS

FIG. 1 is a set of graphs illustrating maximum intensity projections according to an embodiment of the invention.

FIG. 2 is a diagram showing a two dimensional MIP with reference to a two dimensional image, according to an embodiment of the invention.

FIG. 3 is a diagram illustrating a first stage localization of the left ventricle according to an embodiment of the invention.

FIG. 4 is a set of graphs showing maximum projections at each stage of a classification, according to an embodiment of the invention.

FIG. 5 is a diagram showing an original PET dataset and a segmented bounding box encapsulating the left ventricle, according to an embodiment of the invention.

FIG. 6 is a diagram showing an original SPECT dataset and a segmented bounding box encapsulating the left ventricle, according to an embodiment of the invention.

FIG. 7 is a diagram illustrating an apparatus according to an embodiment of the invention.

### DESCRIPTION OF THE PREFERRED EMBODIMENTS

When the following terms are used herein, the accompanying definitions can be applied:

PET—Positron Emission Tomography

ROI—Region of Interest

VOI—Volume (Region) of Interest

SUV—Standardized Uptake Value

LV—Left Ventricle

NN—Nearest Neighbor

This invention is concerned with locating physiological or anatomical features of interest in image data from a scan of a subject. It is applicable to a variety of anatomical features (such as the liver, heart, lungs), and to a number of imaging protocols (such as PET, SPECT) and image types. In general, embodiments generate intensity projection lines along axes of an image volume, compare these to reference data, and use the comparison to find the feature of interest.

The embodiment of the invention described below is directed in particular to the automatic placement of a bounding box around the LV in cardiac images, such as PET and SPECT images, in order to isolate the structure from the rest of the body. Since this is a pre-processing step any method needs to be both fast and accurate.

In the following embodiment, the method uses a classifier based upon a model of the appearance of the LV. Instead of manually selecting a set of thresholds and peak detection heuristics, the method builds the model from a set of training data. For speed, the method also uses maximum intensity projections, comparing MIPs of the test dataset (the image to be analyzed) with three 1-D reference projections from the model dataset, in a fixed order.

Using such an approach offers a number of advantages. Building the model is more principled and straightforward than other previous model-building methods which have to rely upon a more “trial and error” approach.

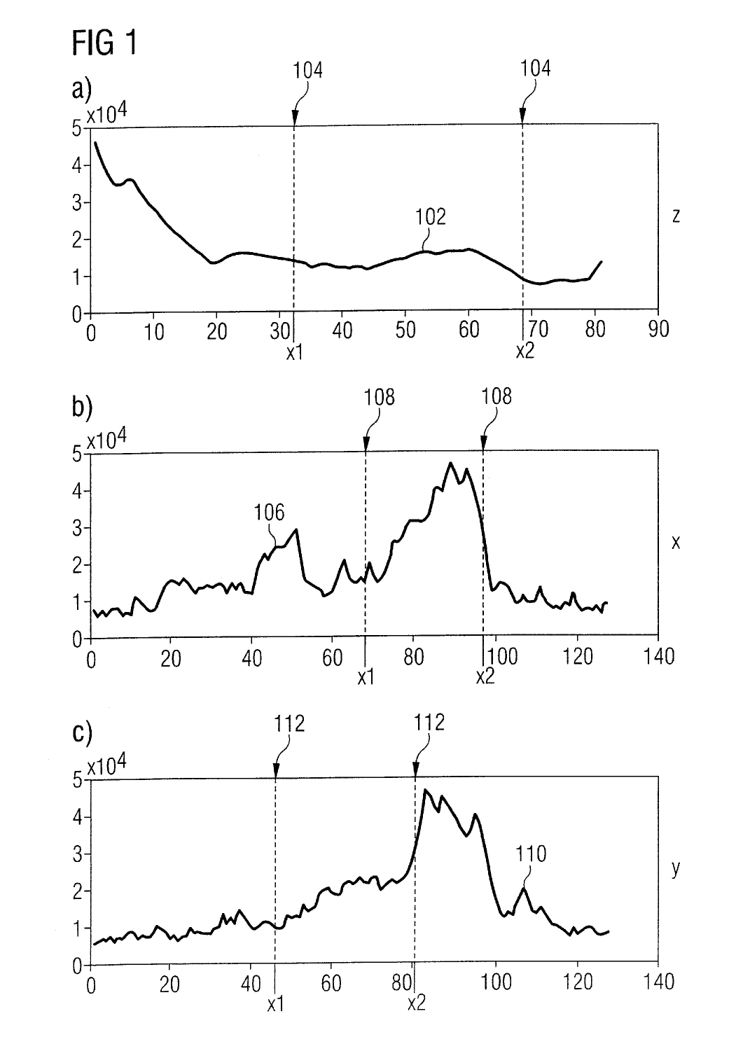

An example of three 1-D maximum intensity projections 102, 106, 110 of PET data (in this case for cardiac imaging) can be seen in FIG. 1. FIG. 1 shows one of the reference or model datasets, where the dashed lines 104, 108, 112 indicate the limits of a manually placed bounding box projected onto the respective axes z, x and y, which forms a boundary around the left ventricle. The further description of the embodiment below explains how these lines are obtained.

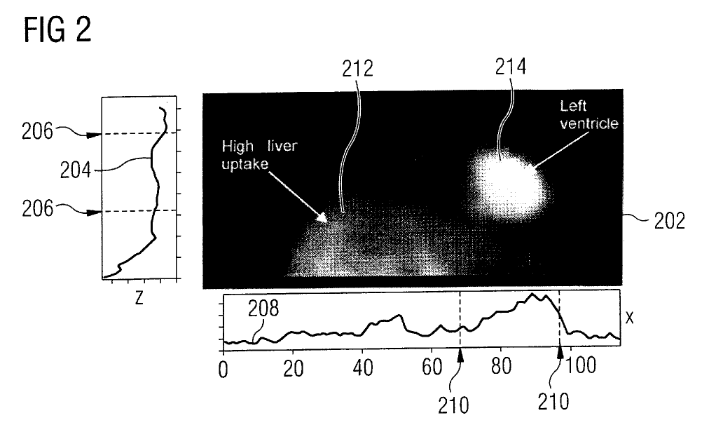

Maximum intensity projections are calculated in each of the 3 orthogonal directions of an image. This is done by taking the intensity of the point within each 2D slice that has the maximum intensity of that slice. This is repeated for each slice along the respective axis and the maximum intensities are plotted across the slices, to give the graphs in FIG. 1. An example of a 2D slice of such an image is the liver/LV slice image 202 shown in FIG. 2. FIG. 2 shows intensity projection examples 204 and 208 for two axes z and x, respectively. For example in FIG. 1(a) (z-axis), the maximum intensity in each of the 81 axial slices is taken and plotted. This is repeated for the sagittal (FIG. 1(b), x) and coronal (FIG. 1(c), y) slices.

FIG. 2 shows only a two dimensional MIP, showing high uptake in the liver 212, which is visible on the two 1D maximum intensity projections 204, 208. The left ventricle 214 is clearly visible; the bounding lines 206 and 210 on the respective axes have been placed to enclose this area of the image slice.

Method Overview: the method of this embodiment works by defining a model of the LV, in terms of 1-D projections, that is then fitted to the test data (image to be analyzed), in order to provide a segmentation of the LV in the test image data.

In the model/reference data, firstly the intensities of 1-D projections are normalized. The model then takes the section of each of the projections that defines the left ventricle. The model consists the whole length from point x1 to point x2 (the dashed lines 104, 108 and 112 in FIG. 1) as a small margin either side of the LV boundary. This length will be variable for different models or reference images due to different sizes of LV.

The exemplar LV section (e.g. between the lines 104 in FIG. 1) can then be fitted to a new test dataset by observing the SSD (sum squared difference) by placing the section at each location along the corresponding MIP from the test dataset. The exemplar section fits at the point where the SSD is minimum, so providing a segmentation of the LV from x1 to x2.

This process is repeated 3 times—for each of the 3 projections. At each repeat stage the volume of the test dataset is reduced as the segmentation is performed. The first stage can be visualized in FIG. 2. This 3 stage cascade approach gives a robust and accurate segmentation of the LV and is fast due to the 1 D projection approach.

Training: a series of models/references are defined for this segmentation, taken from a series of hand segmented training datasets. The maximum projection in the z-direction is calculated, and normalized. A classifier is defined as the bounding box section of the LV, with a small margin on either side. The volume is then reduced using these cut off values and a classifier is then defined for the x direction, again using the normalized projections. The process is then repeated for the y direction:

$${c}_{z}^{t} ( z = {z}_{1} \text{:} {z}_{2} ) = {max}_{x , j} ( I ( x , y , z ) )$$

$${c}_{x}^{t} ( x = {x}_{1} \text{:} {x}_{2} ) = {max}_{y , z = {z}_{1} \text{:} {z}_{2}} ( I ( x , y , z ) )$$

$${c}_{y}^{t} ( y = {y}_{1} \text{:} {y}_{2} ) = {max}_{x + {x}_{1} \text{:} {x}_{2} , z = {z}_{1} \text{:} {z}_{2}} ( I ( x , y , z ) )$$

where

x₁, x₂, y₁, y₂, z₁, z₂

are the edges of the classifier and t is the training set.

In order to extend the training set of models to include regions of different sizes, the maximum intensity projection sections can be re-sampled to different voxel sizes to give the impression of larger and smaller regions. These can then be included in the model training set. This gives a large series of exemplar LV sections that can be used to find the LV in a test dataset.

Segmentation: for each new test dataset, the maximum intensity z-projection is found and normalized, and compared using nearest neighbor, and SSD, to each classifier for a search at each location along the maximum intensity z-projection. In other words, the LV exemplar section from the z-projection of each and every reference profile from the training data is searched along the entire length of the z-projection of the test dataset. The closest match of the classifier to the test data is chosen (i.e. the reference profile having the closest matching LV exemplar in the z-projection) and the test dataset is then segmented in that direction, using the LV bounds set by the matching classifier.

From this test dataset, now segmented in the z direction, a maximum intensity projection in the x-direction is calculated, and the x-classifier applied, to find the best position in the x-direction. The process is then repeated for the y-direction.

Nearest neighbor is a reasonably processing-intensive algorithm. However since the training data is small and the analyses are all on 1D, the algorithm is fast to compute the best fit bounding box of the left ventricle. The test dataset is also reduced in size following each step and segmentation in that direction, thus further reducing computation time.

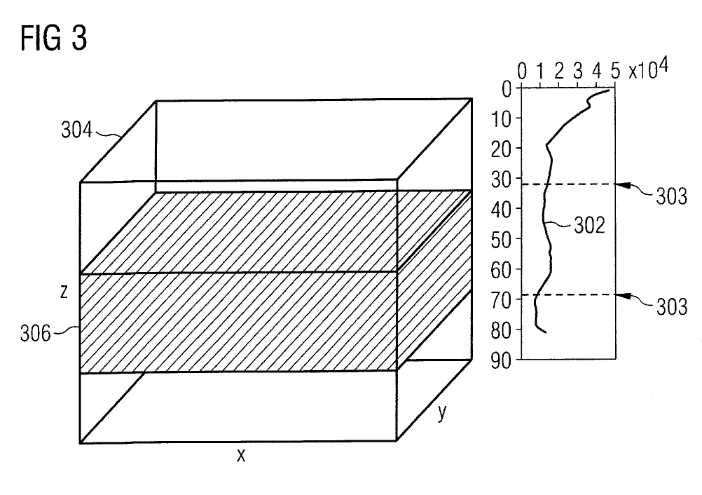

FIG. 3 illustrates the first stage localization of the left ventricle in the z-direction of the dataset. The test dataset 304 is reduced dramatically in size to dataset 306 following the segmentation in the z direction, using the bounds 303 from the classifier.

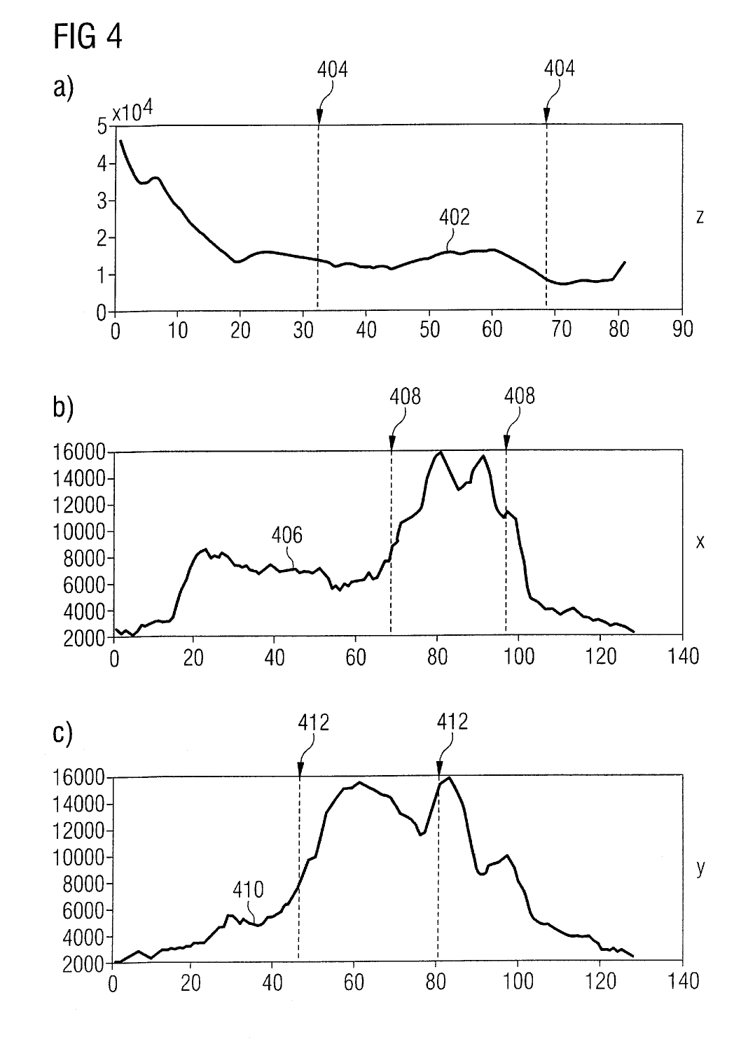

FIG. 4 shows a test dataset, with maximum projections at each stage of the classification, in each of the three directions, with bounds 404, 408, 412 now applied from the closest matching classifiers or reference profiles. As before, the dashed lines indicate the edges of a box which forms a boundary around the left ventricle

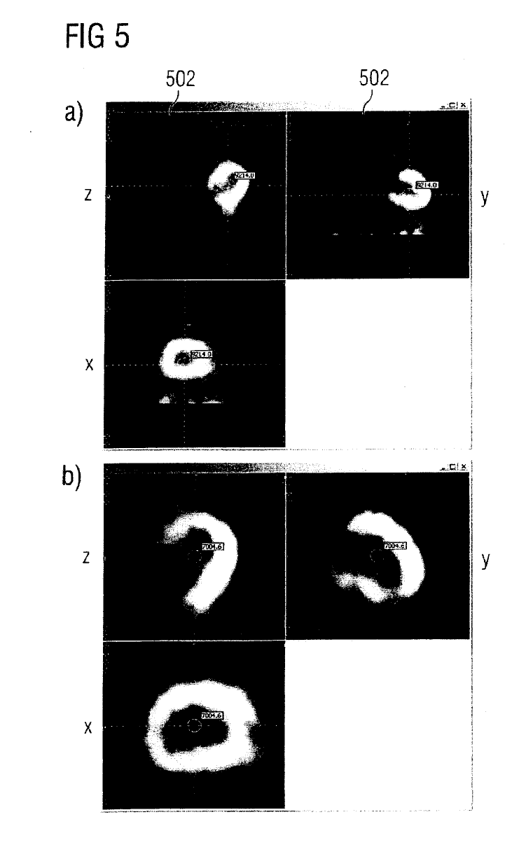

Experimental Results: in an experiment to evaluate this method, a model was trained using 26 datasets that were Rb-82 Non-Attenuation Corrected Rest and Stress PET, from 13 patients. Testing was then applied to 32 unseen test datasets (from 16 patients), and the algorithm succeeded in finding the heart in each case. In order to extend the training set to include LVs of different sizes, the maximum intensity projections were re-sampled to different voxel sizes to give the impression of larger and smaller LVs. That is, the same curves were used a number of times at different ‘scales’. These were then included in the training set. An example of the segmentation can be seen in FIG. 5.

FIG. 5 shows the original PET dataset (a), and the segmented bounding box encapsulating the left ventricle 502. The content of this bounding box is displayed below (b).

The accuracy of such a method is difficult to quantify, since the result is a bounding box, and the training has been defined by hand. However, in the experimental results, the bounding box encapsulated the whole of the left ventricle in each of the test datasets.

The segmentation is deemed to be accurate enough if it is useful for subsequent stages of processing. The time for the algorithm to run and segment one test dataset was 0.7 seconds in MATLAB.

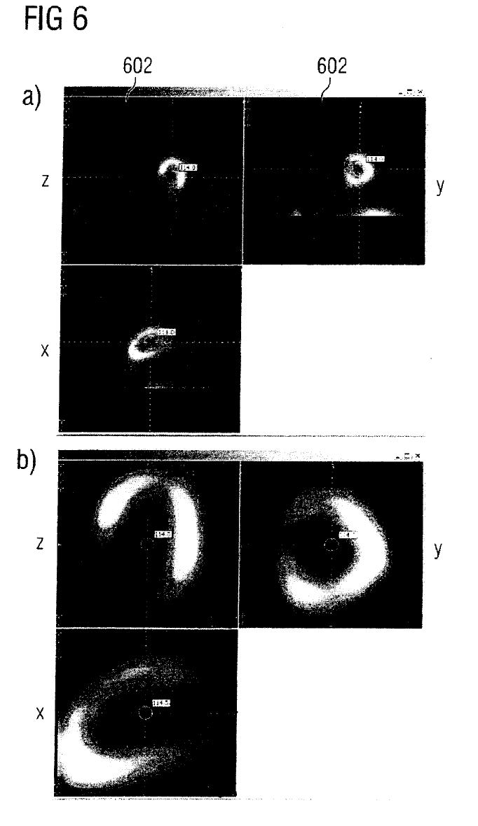

The same method was trained on 30 SPECT cases and tested on 28. Again the algorithm succeeded in finding the left ventricle in each of the test cases. An example of the SPECT segmentation can be seen in FIG. 6. The time for the algorithm to run on the SPECT cases is 0.85 seconds in MATLAB since the datasets are slightly larger.

FIG. 6 shows the original SPECT dataset (a), and the segmented bounding box encapsulating the left ventricle 602. The content of this bounding box is displayed below (b).

Bounding box segmentation done in this way can be used for almost any application in imaging, and the invention could potentially be used for a large variety of 3-D bounding box segmentations in different types of images.

For example, a training dataset could be created for the liver, or for a particular type of lesion. The same manual placement of bound boxes on the training data projections could be used. In an alternative, a semi or fully automatic process for setting the training data bounds around the feature in question could be used.

Summed intensity projections could also be used for the classifier, and the phase of these projections could also be used.

Cross correlation or other similarity measures could be used in place of SSD and this would reduce the need for intensity normalization, however these may increase the processing time.

In the matching steps, alternative processes could be used to reduce complexity and processing power required. For example, the reference MIPs from the training data could be grouped together, or a hierarchy established among them, so that on an initial search of an initial number of the reference profiles, other groups (or parts of the hierarchy) could be disregarded without searching, for example if the similarity to one group is high enough that other groups can be disregarded.

Furthermore, a search within the group structure could be made on a coarse-to-fine basis; having found a closest group of reference profiles, the search would only then be conducted on the members of that group, to find the closest matching profile.

In another alternative, having completed a search for a z-projection, the bounds for the x and y directions could be used automatically, without searching. This would give a less accurate, but quicker result, and may be sufficiently accurate for some applications.

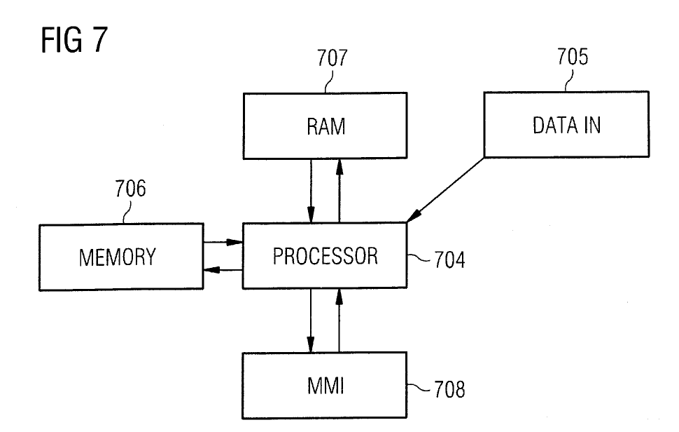

Referring to FIG. 7, the above embodiments of the invention may be conveniently realized as a computer system suitably programmed with instructions for carrying out the steps of the methods according to the invention.

For example, a central processing unit 704 is able to receive data representative of medical scans via a port 705 which could be a reader for portable data storage media (e.g. CD-ROM); a direct link with apparatus such as a medical scanner (not shown) or a connection to a network.

Software applications loaded on memory 706 are executed to process the image data in random access memory 707.

A Man—Machine interface 708 typically includes a keyboard/mouse/screen combination (which allows user input such as initiation of applications) and a screen on which the results of executing the applications are displayed.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method of locating a physiological or anatomical feature of interest in image data of a subject, comprising the steps of:
generating from the image data an intensity projection line along a specified axis of an image volume of the image data;
comparing the projection line to at least one predetermined reference projection line for that specified axis; and
using the comparison to delineate an estimated feature region, containing the feature of interest, within the image volume.

2. A method according to claim 1, wherein the step of comparing comprises comparing the projection line to each of a set of predetermined reference projection lines.

3. A method according to claim 1, wherein the projection line generated is selected from the group consisting of a maximum intensity projection line, and a summed intensity projection line.

4. A method according to claim 2, wherein reference projection lines of the set are grouped according to a similarity measure between respective reference projection lines.

5. A method according to claim 1, wherein the steps of generating and comparing comprise: generating the intensity projection line along each of three orthogonal axes of the image volume; and comparing each generated projection line to at least one respective reference projection line for that axis.

6. A method according to claim 5, wherein the reference projection lines are derived from a three-dimensional training dataset, the dataset comprising a plurality of training images.

7. A method according to claim 6, wherein a set of boundary limits for a reference feature region is associated with each reference projection line.

8. A method according to claim 7, wherein the steps of generating and comparing comprise:
for a first of the three generated projection lines along a first axis, following the comparison of the first projection line with a first reference projection line, cropping the test dataset to the boundary limits associated with the first reference projection line in the direction of the first axis;
deriving a second reference projection line from the cropped test dataset; and
comparing a second of the three generated projection lines along a second axis with said second reference projection line.

9. A method according to claim 7, wherein the step of comparing the projection line to at least one predetermined reference projection line comprises:
comparing a section of the predetermined reference projection line between the set boundary limits, to locations along the projection line from a test dataset; and
using a difference measure to determine the similarity between the section and the projection line at each location.

10. A method according to claim 9, further comprising determining a closest match of the section to the projection line where the difference measure has a minimum value.

11. A method according to claim 7, wherein the step of using the comparison to delineate an estimated feature region comprises:
identifying the boundary limits associated with a closest matching reference projection line to the projection line from the test dataset; and
applying the identified boundary limits to the test dataset projection line to segment the test data set projection line.

12. A method of locating a physiological or anatomical feature of interest in image data of a subject captured by an imaging apparatus, comprising:
generating, in y a processor, from the image data an intensity projection line along a specified axis of an image volume of the image data;
comparing, in said processor, the projection line to at least one predetermined reference projection line for that specified axis;
using, in said processor, the comparison to delineate an estimated feature region, containing the feature of interest, within the image volume; and
displaying the estimated feature region on a display device.

13. An apparatus for locating a physiological or anatomical feature of interest in image data of a subject captured by an imaging apparatus, comprising:
a processor configured to generate from the image data an intensity projection line along a specified axis of an image volume of the image data, to compare the projection line to at least one predetermined reference projection line for that specified axis, and to use the comparison to delineate an estimated feature region, containing the feature of interest, within the image volume; and
a display device connected to said processor that displays the estimated feature region.

14. A computer-readable medium encoded with programming instructions for locating a physiological or anatomical feature of interest in image data of a subject captured by an imaging apparatus, said medium being loadable into a processor and said programming instructions causing said processor to:
generate, from the image data, an intensity projection line along a specified axis of an image volume of the image data;
compare the projection line to at least one predetermined reference projection line for the specified axis; and
use the comparison to delineate an estimated feature region, containing the feature of interest, within the image volume.
